(19) United States
(12) Patent Application Publication
(10) Pub. No.: US 2006/0215742 A1
(43) Pub. Date: Sep. 28, 2006

(54) Optimizing for impulse noise protection in a DSL system

(75) Inventor: Cory S. Modlin, Chevy Chase, MD (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/387,324

(22) Filed: Mar. 23, 2006

Related U.S. Application Data
(60) Provisional application No. 60/664,507, filed on Mar. 23, 2005.

(51) Int. Cl. H04L 5/16

(52) U.S. Cl. 375/222

(57) ABSTRACT

In a digital subscriber line (DSL) network, a net coding gain penalty is determined for provision of impulse noise protection. FEC coding, interleaver depth, and framing parameters are selected to maximize the impulse noise protection while not causing an excessive increase in transmit power or equivalently, loss of net coding gain.

### CROSS-REFERENCE TO RELATED APPLICATIONS

This application claims the benefit of U.S. Provisional Patent Application No. 60/664,507, filed Mar. 23, 2005.

### FIELD OF THE INVENTION

This invention relates in general to telecommunications and, more particularly, to increasing impulse noise protection on a digital subscriber line (DSL) communications system such as an asynchronous DSL (ADSL) system.

### BACKGROUND OF THE INVENTION

A conventional voice-band modem can connect computer users end-to-end through the Public Switched Telephone Network (PSTN). However, the transmission throughput of a voice-band modem is limited to below about 40 Kbps due to the 3.5 KHz bandwidth enforced by bandpass filters and codes at the PSTN interface points. On the other hand the twisted-pair telephone subscriber loop of a computer user has a much wider usable bandwidth. Depending on the length of the subscriber loop, the bandwidth at a loss of 50 dB can be as wide as 1 MHz. Transmission systems based on the local subscriber loops are generally called Digital Subscriber Lines (DSL).

As consumer demand for interactive electronic access to entertainment (e.g. video-on-demand) and information (Internet) in digital format has increased, this demand has effectively exceeded the capabilities of conventional voice-band modems. In response, various delivery approaches have been proposed, such as optical fiber links to every home, direct satellite transmission, and wideband coaxial cable. However, these approaches are often too costly, and cheaper alternatives have emerged, such as the cable modem which uses existing coaxial cable connections to homes and various high bit rate digital subscriber line (DSL) modems which use the existing twisted-pair of copper wires connecting a home to the telephone company central office (CO).

An example of prior art use of DSL techniques is the Asymmetrical Digital Subscriber Line (ADSL) signaling for the telephone loop that has been defined by standards bodies as a communication system specification that provides a low-rate data stream from the residence to the CO (upstream), and a high-rate data stream from the CO to the residence (downstream). The ADSL standard provides for operation without affecting conventional voice telephone communications, e.g. plain old telephone service (POTS). The ADSL upstream channel only provides simple control functions or low-rate data transfers. The high-rate downstream channel provides a much higher throughput. This asymmetrical information flow is desirable for applications such as video-on-demand (VOD). The ADSL standards are defined in ITU (International Telecommunications Union) G.992. x group of recommendations for ADSL and ADSL2.

ADSL modems are typically installed in pairs, with one of the modems installed in a home and the other in the telephone company's central office servicing that home. The pair of ADSL modems are connected to the opposite ends of the same twisted-pair and each modem can only communicate with the modem at the other end of the twisted-pair; the central office will have a direct connection from its ADSL modem to the service provided (e.g., movies, Internet, etc.).

A typical ADSL-based system includes a server located at the CO capable of providing movies or other data-intensive content, and a set-top-box at the residence that can receive and reassemble the data as well as send control information back to the CO. Meaningful display or use of the downstream content typically requires a sustained data rate through the modem. Due to the sustained data rate requirements, ADSL systems are primarily designed to function under certain operating conditions and only at certain rates. If a subscriber line meets the quality requirements, the ADSL modem can function, otherwise new line equipment must be installed, or line quality must be improved.

In contrast, an ADSL modem operates in a frequency range that is higher than the voice-band; this permits higher data rates. However, the twisted-pair subscriber line has distortion and losses which increase with frequency and line length; thus the ADSL standard data rate is determined by a maximum achievable rate for a length of subscriber lines, e.g. 9,000 feet (9 kft) for 26 gauge lines, or 12 kft for 24 gauge lines.

However, these DSL modems have problems including: 1) higher bit rates for video that cause them to be complicated and expensive; 2) their bit rates are optimized for a fixed distance, making them inefficient for short subscriber loops and unusable for long subscriber loops; and 3) either DMT or CAP operates better for given different conditions (e.g. noise, etc.) that may or may not be present in a particular subscriber loop to which the DSL modem is connected.

The popularity of using faster connection speeds to the Internet using a DSL system also causes a rise in customer demands of high quality of service without network errors or unreasonable delays. DSL providers design their networks to maintain a balance between transmission power to sub-carriers and minimizing errors caused by noise, and minimizing end-to-end delays. In DSL networks using DMT modulation, impulse noise can cause significant problems and even catastrophic signal loss. Impulse noise can be caused by non-stationary energy bursts that have fairly high energy and can be caused by numerous factors in the lines including physical and electromagnetical interferences as well as external devices near network lines. Traditional methods to shield against impulse noise include using increased margins in a network system through a combination of interleaving, encoding with Reed-Solomon error-correction codes, and/or increasing the transmission power.

In a DSL modem, the interleaver performs an interleaving function on the data frames output from an FEC module. An interleaver/deinterleaver is a pair of building blocks normally used in a digital control and communication system to increase the stability of the system. In general, interleaving spreads the consecutive burst errors introduced into the system to many non-consecutive places so that errors may be easily detected or corrected by, for example, a forward error control (FEC) coding block. The interleaver and deinterleaver may be used together with Reed-Solomon FEC (Forward Error Correction) code to combat the impulse noise on a twisted pair telephone line. The interleaving depth is a parameter that is equal to the number of data bytes in the outgoing interleaved data stream between two data bytes of one and the same codeword or fraction of a codeword. The interleaving depth is a quantitative indicator of the enhancement of immunity of the transmission for burst noise.

Framing in DSL is the process of taking a stream of incoming data, applying both a Reed-Solomon and trellis code, and then packing the bits onto sub-carriers in DMT frames. Framing allows a broad range of coding parameters and data rates. It allows the incoming data stream to be divided into different paths, each path with different framing parameters. ADSL2 framing also provides an overhead channel transmitted along with the user data for the exchange of management messages and data. In all ADSL recommendations, the DMT frame (symbol) rate is 2.208×106/544=4058.8 frames per second or about 246.4 μs per DMT frame. This is true for upstream, downstream, ADSL1, ADSL2, and ADSL2+because as the number of sub-carriers changes, the sampling rate changes by the same ratio keeping the frame duration and the sub-carrier bandwidth constant. Every 69th frame is a synch symbol that carries no data. Therefore, the effective DMT frame rate is 4058.8*68/69=4000 frames/second.

FIG. 1 illustrates framing used in ADSL2. In ADSL2, every DMT frame 2 carries any integer number of bits and every DMT frame 2 carries the same number of bits. The number of bits actually loaded into every DMT frames depends on many things such as the SNR of each sub-carrier, the desired data rate, the code and its coding gain, the overhead data rate, and the restrictions placed by the framing. Every DMT frame can carry data streams from different bearer channels and different latency paths. ADSL2 defines up to four bearer channels and up to four latency paths. More than one bearer channels can be carried over the same latency path but one bearer channel can not be divided over multiple latency paths. The index denoting the bearer channel is N and the index denoting the latency path is the subscript p.

In addition to a DMT data frame, ADSL defines an FEC data frame 4. An FEC data frame 4 contains an integer number of octets (bytes) 8 and redundant bytes 6 makes up one FEC codeword. Even when the Reed-Solomon code is disabled (i.e., Rp=0), ADSL2 still uses the FEC data frame.

In ADSL networks, a rate adaptation is the process of taking measured line conditions (SNR) and finding the most appropriate data rate, coding and framing parameters, and DMT bit allocation. In general, the rate adaptation process under ADSL2 has four phases. During the rate adaptation process in a DSL system, the CO receives a signal from each of the DMT sub-carriers that are downstream. From this signal the signal power and noise power are measured and the signal-to-noise ratio (SNR) determined for every sub-carrier. Based on this information, the parameters for trellis coding, the Reed-Solomon (RS) code, and interleaver depth are chosen for each sub-carrier. The data rate is then calculated and the margin adjusted, after which the process forces convergence to the exact number of bits desired, calculates the reported margin and fine gains, and determines monitored sub-carriers. Certain assumptions are used in this process as well. The first is that the larger the RS codeword size, the higher the net coding gain and therefore, the higher the data rate. Net coding gain is defined as the additional transmitted power that is required without coding to obtain the same net data rate and error rate as that obtained with coding. Gross coding gain can be defined similarly except using the data rate that includes coding overhead. Next, the overall end-to-end delay (except for processing delay and encoder/decoder delay) is nearly proportional to the interleaver depth, Dp, and the codeword size, N_FECp.

During the second stage of the rate adaptation process, trellis coding, Reed-Solomon coding, and error rate parameters are determined. All possible coding gains are looped through in order to find the one that results in the highest net data rate.

For each gross coding gain, the number of bits loaded per DMT symbol are estimated using pre-calculated assumptions about Reed-Solomon and trellis coding gain. Further estimates include the number of DMT sub-carriers loaded with only one bit and those with more than one bit because the number of trellis-coded bits is calculated differently for one-bit sub-carriers and sub-carriers with more than one bit. Ideally, the bit loading algorithm would be run for each new gross coding gain value. The bit loading algorithm analyzes each sub-carrier and assigns bits according to the SNR level, margin, and assumed coding gain. However, running this algorithm for each coding gain is not practical given the constraints on computation time, especially in the downstream direction where there are numerous sub-carriers.

Certain assumptions are made in this stage. The first assumption is that the larger the RS codeword size, the higher the net coding gain and therefore, the higher the net data rate. The overall end-to-end delay, except for processing delay and encoder/decoder delay, is proportional to the interleaver depth, Dₚ, times Sₚ, the number of DMT codewords per RS codeword. The longer the codeword size, the higher Sₚ and therefore, the lower the allowed interleaver depth at a given delay. Another assumption is that the noise is Additive White Gaussian Noise (AWGN) and independent.

Due to changes in noise environments and to protect against impulse noise, DSL providers operate the system at a margin higher than is theoretically necessary to achieve a bit error rate. If a certain SNR is necessary to achieve 10⁻⁷ bit error rate at a given data rate, for example 10 dB, a provider may operate the system at this same data rate with an SNR of 16 dB to make sure that under most noise conditions the network will continue to operate at the target error rate. This would be a 6 dB margin. It is common for DSL operators that are receiving complaints from subscribers about errors in lines from customers, to increase the power even at low data rates and on short loops where impulse noise is a problem. An increase of high power in a line increases the margin but also causes a few penalties, namely the higher power will cause cross-talk into neighboring lines so the overall system capacity is actually lower. Another problem is that there is no guarantee that even an extremely large margin from using high power will solve the problem of impulse noise. For example, a split second break in the line will cause catastrophic errors no matter what the power level is set to. To recover from such an event, the Reed Solomon coding is used. If the break is short enough to be recovered from the redundancy level set in the RS code, then the user will not experience an error. The RS coding parameters are set by the rate adaptation which is the algorithm which chooses the coding parameters and the number of bits and the code size.

Network service providers use rate adaptation algorithms to maximize the data rates on transmissions. Maximizing the data rate may be desirable if a DSL service is delivering video services, for example. Another conventional rate adaptation algorithm is to minimize the transmission power in the system at a given data rate, which is optimal operation of a DSL system in the sense that it reduces crosstalk. However, these two operations have a trade-off in performance.

INP for latency path p is described by the equation

$${INP}_{p} = \frac{8 {D}_{p} t}{{L}_{p}} = \frac{{S}_{p} {D}_{p} t}{{N}_{{FEC}_{p}}}$$

where t is the correction capability of the Reed-Solomon code, equal to Rp/2 when erasure decoding is not used, and

$${S}_{p} = \frac{8 {N}_{{FEC}_{p}}}{{L}_{p}}$$

To maximize INP, we can use very small codewords in order to maximize the interleaver depth, Dp, for a given delay requirement. N_{FECp} is the codeword size in bytes, and L_{P} is the number of Reed-Solomon coded bits per DMT symbol. Framing in ADSL is the process of taking a stream of incoming data, applying both a Reed-Solomon and trellis code, and then packing the bits onto sub-carriers in DMT frames.

In addition to maximizing INP_{P}, the prior methods find an interleaver depth Dₚ that meets the delay requirements. Thus, the larger the interleaver depth, the higher the INP. In ADSL2,
N_{FECp}=Mₚ*Kₚ+Rₚ
where Rₚ is the number of redundant bytes per Reed-Solomon codeword and Mₚ is the number of mux data frames per codeword. Solving for Lₚ in the above equation and substituting for N_{FECp}, results in the following:
Lₚ=(8*Mₚ*Kₚ+8*Rₚ)/Sₚ
where Lₚ must be an integer. To simplify things, it is required that (8*Mₚ*Kₚ)/Sₚ be an integer and that (8*Rₚ)/Sₚ also be an integer. Since neither Mₚ nor Rₚ are allowed to go higher than 16, the numerator in Sₚ can not exceed 8*16=128. In the previous equation, Kₚ is the number of information bytes and since Rₚ is the number of coded bytes when the redundant coding is increased it creates more Rₚ bytes per K bytes.

Current methods to maximize INP, when there is margin in the DSL system, choose a codeword that has a maximum of 16 redundant bytes, so Rₚₘₐₓ=16. Thus, if Nₚ is set to 17 bytes, there is one information byte transmitted per codeword. This results in a very low coding gain because of the 16-byte overhead transmitted with each word for each byte of information. To use such a coding method, the transmission power in the system must be increased, further adding inefficiencies into the system, and making this a poor solution for maximizing INP. Thus, a trade-off of an increase in overhead in coded transmissions is the result of an increase in the ability to correct for INP errors. For example, the net data rate is calculated L(K/N)*4000, where L is the number of bits per symbol. There are 4000 symbols per second if K/N is small, (such as K=16 and N=32, and therefore the data rate and efficiency are cut in half. Under these parameters, the Reed-Solomon code has a 50% redundancy in the data transmissions, which is a protection against INP but poor net data rate.

Thus, maximizing Sₚ and finding the optimum interleaver depth Dₚ leads to the highest possible net coding gain, when N is as large as possible and provides the highest possible data rate. However, this solution fails to provide for the maximum impulse noise protection. There are scenarios where a provider would rather have the highest possible impulse noise protection instead of the highest possible data rate. For example, on a short loop for which the operator limits the data rate to one that is easily achievable, say 768 kbps for example, it might be desirable to sacrifice coding efficiency for impulse noise protection.

### SUMMARY OF THE INVENTION

In the present invention, a DSL telecommunications system includes a telecommunications line, a first DSL modem coupled to the line operable to communicate data over either a first or second frequency spectrum, and a second DSL modem coupled to the telecommunications line.

In ADSL operations on a subscriber network, impulse noise protection is provided during rate adaptation procedures. A maximum efficiency for the network is determined between net coding gain, transmission power, and reduction in margin of the network. Safeguards in coding and power selection prevent a large negative net coding gain.

### BRIEF DESCRIPTION OF THE DRAWINGS

For a better understanding of the nature of the present invention, its features and advantages, the subsequent detailed description is presented in connection with accompanying drawings in which:

FIG. 1 illustrates a framing diagram for an ADSL framing scheme;

FIG. 2 illustrates a system depicting by way of example the context in which the present inventive embodiments may be implemented;

FIG. 3 is a flowchart of the a method of the preferred embodiment;

FIG. 4 is a flowchart illustrating more details of the method of the preferred embodiment.

### DETAILED DESCRIPTION OF THE INVENTION

The preferred embodiment is a technique used in a method and a system for Asymmetric Digital Subscriber Line (ADSL) networks. Although the present invention is not limited by the following standards, the preferred methods and systems follow rate adaptation standards in the industry, such as the rate adaptations found in ITU recommendation G.992.3 “Asymmetric Digital Subscriber Line (ADSL) Transceivers—2(ADSL2)” and ITU recommendation G.992.5, “Asymmetric Digital Subscriber Line (ADSL) Transceivers—Extended Bandwidth ADSL2 (ADSL2plus) that are incorporated by reference.

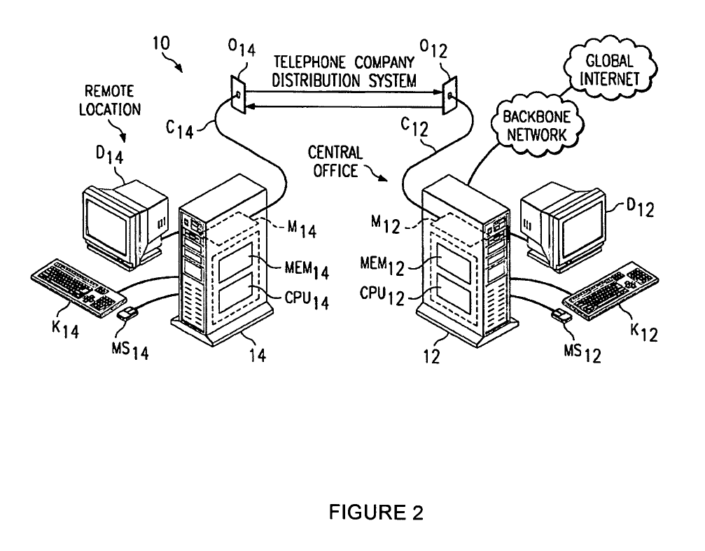

FIG. 2 illustrates a system 10 depicting by way of example the context in which the present inventive embodiments may be implemented. By way of example, system 10 includes aspects which relate to two different geographic locations, one being a telephone company central office and the other being a location remote from that office and, hence, referred to in this document as a remote location. For purposes of appreciating a common example, the remote location may be a home or office of a user in that location, while the central office may be any of those types of offices included in a telephone company system. Stated simply, therefore, these two locations may be fairly close together, or vast distances apart, yet they both may benefit from the present embodiments. These benefits as well as the details of the inventive embodiments are presented below.

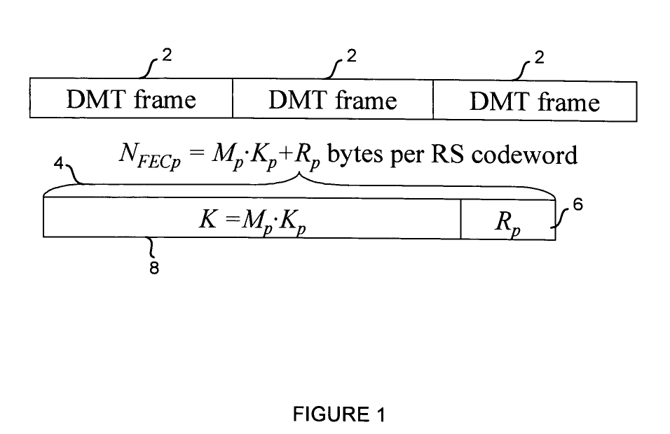

At a minimum for illustrating the preferred embodiments, each of the central office and remote location houses a computer 12 and 14, respectively. Computers 12 and 14 may be of any type of known computer configurations and, indeed, the type of computing device at the remote location may well differ from the type or configuration of that used at the central office (e.g., a rack system). Computer 12 may be located at a central office (CO) and computer 14 may be located at a customer site downstream of the CO as customer premisis equipment (CPE). Typically, therefore, a user of either computer may provide input to a corresponding computer, such as by way of a keyboard K and a mouse MS or other input or pointing device as known in the art. To simplify the present illustration, note for purposes of FIG. 1 that each of the reference identifiers for these items (i.e., K and MS) as well as for other items discussed below further includes a subscript reciting the reference number of the corresponding computer. For example, computer 12 includes keyboard K.sub.12 and mouse MS.sub.12. Continuing with this convention and looking to other attributes of computers 12 and 14, each computer preferably includes some device for presenting output to a user, such as a display D. Internally to each computer may be various circuits including those mounted on circuit boards and/or cards, including a motherboard (shown in phantom) which includes a memory MEM, a central processing unit CPU or more than one such CPU as may likely be the case for computer 12, and likely other circuitry (not shown).

Of particular note to the present embodiments, also included preferably internal to each computer and, thus, shown in phantom, is a modem M having a receiver and transmitter so that each of computers 12 and 14 may communicate with one another over a standard telephone company distribution system. In the case of computer 12, note that it is likely to actually include and support multiple modems, although only one is shown to simplify the illustration as well as the following discussion. Looking to the distribution system along which the modems communicate, it includes twisted conductor pairs accessible for a connection between computers 12 and 14. In this regard, modem M.sub.14 of computer 14 provides an output which is provided to a standard telephone or other applicable connector and, thus, is connected to a telephone wall outlet O.sub.14 via a standard telephone communication cable C.sub.14. This connection permits communication from modem M.sub.14 over the telephone company distribution system and, therefore, with modem M.sub.12 of computer 12. Note that while comparable connections using cable C.sub.12 and outlet O.sub.12 are shown at the telephone company, more typical industrial type connections may actually exist at that end of the connection. Lastly, given the communications of modems M.sub.12 and M.sub.14 with one another, note that in the preferred embodiment such communications are by way of a DSL category referred to as Medium-bit-rate Digital Subscriber Line (MDSL) technology, which currently contemplates downstream communications up to 2.8 Mbps and upstream communications up to 768 Kbps. One skilled in the art, however, will appreciate that many of the present teachings also provide aspects and benefits which may be implemented in other DSL categories.

Given system 10 of FIG. 2, it is intended that its components are used within the present inventive scope to accomplish DSL communications between modems M.sub.12 and M.sub.14. In this regard, note that computer 12 is connected via an appropriate interface I/F to a backbone network. This network may be of various types, with Ethernet being a popular contemporary example. As a result, computer 12 may communicate with any other device or resource which also is coupled to communicate with the backbone network. Indeed, as one example, FIG. 2 illustrates that the Internet is also coupled to the backbone network through some kind of networking architecture. Consequently, computer 12 may communicate, via the backbone network, with the Internet Additionally, due to the modem-to-modem communication path between computers 12 and 14, computer 14 also may use DSL communications for accessing other media available to computer 12 at the telephone company central office. In the system of FIG. 2, while both ADSL modem M12 may be connected over network lines to an Internet Protocol (IP) phone or an IP video device (not shown) and handle transmissions for these devices.

The preferred embodiments maximize impulse noise protection (INP) while maintaining that data rate requirements in an ADSL system 10. Impulse noise protection is given in the following equation:

$$INP = \frac{8 {tD}_{p}}{{L}_{p}} DMT frames$$

In this equation, t is the error correcting capability of the Reed-Solomon code which is normally Rₚ/2 with no erasure decoding or Rₚ if erasures are used. According to the above equation, impulse noise protection is maximized when t (or equivalently Rₚ) and Dₚ are maximized and Lₚ is minimized. Since in this case, Lₚ is determined by the data rate target, we maximize impulse noise protection by selecting the highest Rₚ and Dₚ that will still allow us to meet the data rate target.

A penalty for optimizing for impulse noise protection in ADSL is reduced coding efficiency. This means that to operate at a given margin, data must be transmitted at a higher power. In other words, at a given transmit power the margin for the network is reduced. This has the undesirable effect that the total transmit power will be higher and this power causes crosstalk interference into neighboring DSL lines. However, this additional power is typically much lower than the additional power that is required to maintain a margin of greater than 16 dB to prevent bit errors on impulse-noisy loops. Typically, the additional power relative to an optimized net coding gain, is not more than 5 dB.

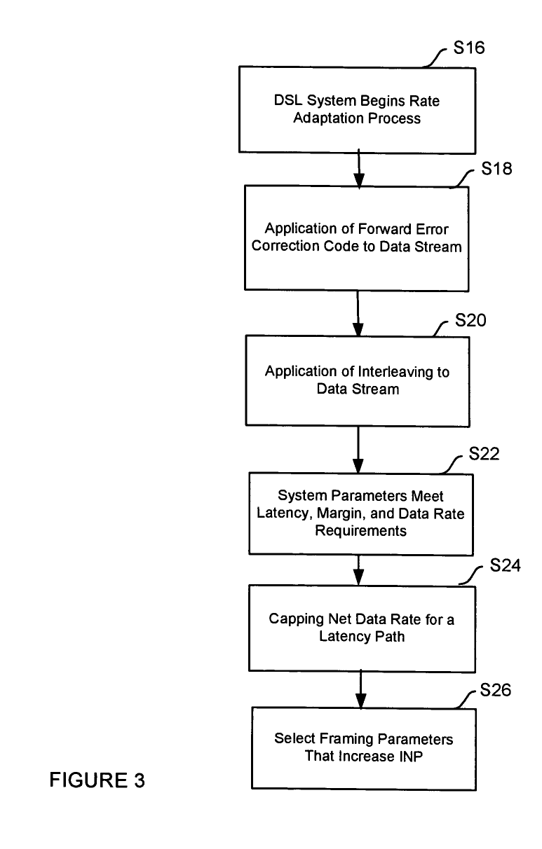

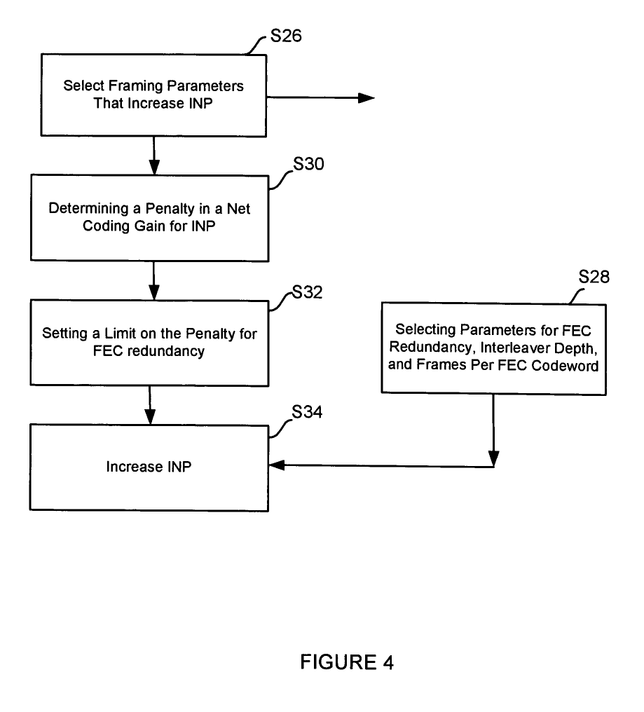

The flowcharts in FIGS. 3 and 4 may be referenced in order to illustrate the preferred and alternative embodiments described herein. The preferred embodiment is an alternative criteria to the conventional methods of improving INP in a DSL system. In DSL systems where the data rate is capped in the DSL transmission, the preferred method maximizes the INP but still meets the data rate requirements of the system. The preferred embodiment determines a rule with a penalty for transmission and coding parameters that results in an enhanced solution to INP protection.

During rate adaptation S16, the Reed-Solomon (RS) code S18 and interleaving of the data stream S20 are applied to each sub-carrier. Once rate adaptation S16 determines that the system parameters meet latency, margin, and maximum data rates S22, the loading algorithm criteria changes from maximizing the net coding gain to maximizing Dₚ·Rₚ with the goal being to maximize INP as in the INP equation listed above. Since the system is longer optimizing the net coding gain (under an AWGN assumption), this means that the margin will be smaller or equivalently, that the total transmit power will be higher than if the system had optimized for net coding gain.

In an example of the present invention, an ADSL system specified with a maximum delay of 8 ms on a short loop, the best net coding gain normally results from running with the trellis code on and no Reed-Solomon code. This is because the trellis code causes burst errors and, without sufficient interleaving, the Reed-Solomon code offers no further net coding gain. With the ADSL system encoding with the trellis code only, the net coding gain is typically around 3.5 dB to 4 dB and there is no impulse noise protection. However, if the system was instead optimized for impulse noise protection, then the system would most likely have the trellis code disabled, and the Reed-Solomon FEC code applied S18 with parameters set to Rₚ=16, Dₚ=16 and Sₚ≈0.8 (since ceil(Sₚ*Dₚ)/4+3.75 would be 7.75 ms). At a low data rate like 760 kbps (kilo-bit per second) for example, N_{FECp}=35, Lₚ=350, and the impulse noise protection is 8*Dₚ*(Rₚ)/350=2.9 DMT frames. The values for N_{FECp} and Lₚ are derived from the third line in the following equation for calculating the approximate net data rate:

$$net data rate = \frac{{N}_{{FEC}_{p}} - {R}_{p}}{{S}_{p}} * 32 - {OR}_{p max} kbps$$

where ORₚₘₐₓ is the overhead channel rate derived while finding the largest possible value for Sₚ. The actual overhead rate can be reduced if Tₚ>1.

When the net data rate is capped for a latency path S24, the framing parameters selected S26 for optimized impulse noise protection will have a smaller net coding gain than the trellis-only selection depending on the number of active sub-carriers. In example, for a downstream with 122 sub-carriers, the net coding gain of this code is about 3.1 dB (about 7.0 dB gross gain—about 3.9 dB loss for adding 16 redundant bytes over 0.8 DMT frames assuming 3 dB/bit/sub-carrier). This difference in net coding gain between the 4 dB for the trellis code and 3.1 dB for the impulse noise optimized solution translates into a 0.9 dB increase in transmit power or a reduction in margin.

In the preferred embodiment for optimizing INP, safeguards are added to prevent undesirable solutions. A solution with a large negative net coding gain is not a desirable solution. Noting that the gross coding gain for a Reed-Solomon code is rarely over 6 dB, penalty is restricted for redundancy to about 6 dB. The reason for this is that the loss in net coding gain results in increased transmit power, which will interfere with adjacent modems and is not consistent with the goals of dynamic spectral management (DSM). Thus, a penalty can be determined in a net coding gain for INP S30. As an example, the penalty for the Reed-Solomon redundancy can be written, again assuming 3 dB/bit/sub-carrier
penalty=8·R·3/(number of sub-carriers·S)dB
One of an increase in S or decrease in R is made until this penalty is less than 6 dB.

The safeguards implemented to prevent a penalty of less than 6dB only apply when there is no other reason for the penalty to exceed 6 dB. If another input to rate adaptation necessitates a penalty greater than 6 dB, the safeguard is overridden. Increasing INP under a safety penalty limit S32 includes selecting parameters for FEC redundancy, interleaver depth, and DMT frames per codeword that maximize INP S28. For example, if the operator sets INP=2, the maximum delay to 6 ms, and the data rate to 768 kbps, rate adaptation will select t=8 (R=16 assuming no erasure decoding), D=8 (maximum allowed upstream), and S=1. In the upstream direction, with 24 sub-carriers, the penalty for the Reed-Solomon redundancy would be 16 dB, which exceeds 6 dB.

As is understood by one skilled in the art, the penalty rule, listed above, is merely one example of the rule of the preferred embodiment. The preferred method uses rules developed to show that there is a penalty in net coding gain for maximizing the INP, and this method limits the penalty to no more than some number of decibels that prevents an undesirable solution to INP. An undesirable solution is one in which the net coding gain from the Reed-Solomon code is strongly negative. The preferred embodiment limits the net coding gain to some value, which could even be a negative value. However, a large value of negative net coding gain, such as −20 dB or −30 dB, would be undesirable. The preferred method limits the loss from the Reed-Solomon code or limits the net coding gain to some reasonably low value. The result of the preferred technique for INP is generally lower power in the system than is conventionally attained by simply increasing the margin. Furthermore, with the lower power in the system INP is increased.

In implementing the preferred method for INP, the programming code of the CO and downstream modems in the DSL system should be modified to cap the negative penalty for INP. The preferred method, implemented as a rule for achieving the goal of INP such that the net coding gain is not too negative or too small, operates between the CO modem and the modems that are part of the the downstream customer premise equipment (CPE).

In a preferred embodiment, the present features to maximize INP are always enabled in the downstream and upstream directions. However, in an alternative embodiment, a network management system can selectively enable or disable these features in modems in the downstream direction (at the ATU-R) using a signal such as a proprietary message. The proprietary message could be a parameter such as “maximiizeinp” that is transmitted to the receiver of each downstream modem. The message parameter may also be included as an input to rate adaptation to determine whether or not to switch to the preferred method of INP.

One skilled in the art will appreciate that the present invention can be practiced by other than the described embodiments, which are presented for purposes of illustration and not limitation, and the present invention is limited only by the claims that follow.

What is claimed is:

1. A method used during rate adaptation in a digitial subscriber line (DSL), comprising:
applying a forward error correction (FEC) code to a data stream,
applying interleaving to the data stream; and
meeting latency, margin, and data rate requirements for the data stream, wherein when a net data rate for a latency path is capped, the criteria used to select framing parameters results in an increase in the impulse noise protection (INP).

2. The method of claim 1, further comprising: determining a penalty in a net coding gain for protecting against impulse noise in the network caused by redundancy in FEC codewords and a number of frames per FEC codeword in the FEC code.

3. The method of claim 2, further comprising:
setting a penalty limit for redundancy in the FEC code so that a loss in the net coding gain caused by the redundancy does not result in an unreasonable increase in transmit power.

4. The method of claim 3, wherein the criteria used to select parameters of claim 1 comprises selecting parameters for the FEC redundancy, an interleaver depth, and the number of DMT frames per FEC codeword that do not cause the transceiver to exceed the penalty limit.

5. The method of claim 1, further comprising:
transmitting a one of a message and signal from the central office transceiver to the customer premisis equipment (CPE) to signal that framing parameters should be selected to increase the impulse noise protection.

6. The method of claim 5, further comprising:
transmitting one of the message and signal from the central office transceiver to the customer premisis equipment (CPE) to indicate the penalty.

7. The method of claim 1, wherein the method is performed on an ADSL system; and
a net coding gain in the system from an increase in redundancy in the Reed-Solomon code does not fall below a penalty limit for a drop in net coding gain that is based upon interference between sub-carriers caused by an increase in transmission power in the system.

8. A system for data transmission, comprising:
a first modem at a central office on a digital subscriber line (DSL line) transmitting a downstream data stream and receiving an upstream data stream;
a second modem, operatively connected to the first modem as a downstream sub-carrier on the DSL line, transmitting the upstream data stream and receiving the downstream data stream,
wherein the first modem applies a forward error correction (FEC) code to the downstream data stream, an interleaving to the downstream data stream, and meets latency, margin, and data rate requirements for the downstream data stream, and
wherein when a net data rate for a latency path is capped on the downstream data stream, the criteria used to select framing parameters results in an increase in the impulse noise protection (INP).

9. The system of claim 8, wherein the second modem applies a forward error correction (FEC) code to the upstream data stream, an interleaving to the upstream data stream, and meets latency, margin, and data rate requirements for the upstream data stream, and
wherein when a net data rate for a latency path is capped on the upstream data stream, the criteria used to select framing parameters results in an increase in the impulse noise protection (INP).

10. The method of claim 8, wherein the central office determines a penalty in a net coding gain for protecting against impulse noise in the network caused by redundancy in FEC codewords and a number of frames per FEC codeword in the FEC code.

11. The method of claim 10, wherein the central office sets a penalty limit for redundancy in the FEC code so that a loss in the net coding gain caused by the redundancy does not result in an unreasonable increase in transmit power.
